(19) United States
(12) Patent Application Publication
(10) Pub. No.: US 2007/0207715 A1
(43) Pub. Date: Sep. 6, 2007

(54) CUTTING TOOL INSERT WITH MOLDED INSERT BODY

(76) Inventor: Steven Webb, Worthington, OH (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/682,775

(22) Filed: Mar. 6, 2007

Related U.S. Application Data
(60) Provisional application No. 60/779,532, filed on Mar. 6, 2006.

(51) Int. Cl. B23F 21/03

(52) U.S. Cl. 451/540

(57) ABSTRACT

A cutting tool comprising may include at least one abrasive tip that includes an abrasive cutting edge, and an insert body. The insert body includes a moldable material, and the moldable material is adhered to a portion of the abrasive tip.

### CROSS-REFERENCE TO RELATED APPLICATIONS

This patent application claims priority to co-pending U.S. provisional patent application No. 60/779,532, entitled “Cutting Tool Insert with Molded Insert Body”, and filed on Mar. 6, 2006, the disclosure of which is incorporated herein by reference in its entirety.

### STATEMENT REGARDING FEDERALLY SPONSORED RESEARCH

Not applicable.

### NAMES OF PARTIES TO A JOINT RESEARCH AGREEMENT

Not applicable.

### SEQUENCE LISTING

Not applicable.

### BACKGROUND

1. Technical Field

The description set forth herein relates generally to cutting tool inserts having a molded insert body and methods of manufacturing cutting tool inserts.

2. Description of the Related Art

Machining, cutting sawing or drilling cutting tools are often provided with removable inserts including conventional materials such as cemented carbides or ceramics (e.g. Si₃N₄, TiC—Al₂—O composites). FIGS. 1A, 1B and 1C depict a conventional insert 10 firmly held and locked into a cutting tool holder 15 by a screw or other clamping, mechanism 14. These inserts are a disposable part of the machine cutting tool system because, in machining operations, the insert is held in contact with the work piece and eventually wears to a point requiring replacement. Superabrasive materials containing diamond, for example, polycrystalline diamond (PCD), and/or cubic boron nitride, for example, polycrystalline cubic boron nitride (PCBN), provide enhanced machining performance over conventional materials and are also widely used as cutting tool inserts. However, due to material and/or other costs, use of superabrasive materials may be impractical in many applications. Thus, due to the high material and/or production costs, fabrication techniques have been developed and optimized to reduce the usage of superabrasives, for example on the insert.

One such technique is the manufacture of a cutting tool insert as described above and depicted in FIGS. 1A, 1B, and 1C. The cutting tool insert 10 may include an insert body 13 having a substrate material and an abrasive cutting edge 12 which may be of superabrasive material, with the insert body 13 being typically fabricated out of pre-manufactured cemented tungsten carbide. The superabrasive cutting edge 12 may be attached to a corner, edge, center periphery of or otherwise in contact with, the insert body 13 by a brazing process. Brazing often provides sufficient binding force to withstand the cutting forces and heat and is additionally convenient for attaching small abrasive cutting edges. The cutting tool insert 10 may then fixed via a clamp 14 or wedge to the cutting tool holder 15. The cutting tool holder is then clamped or wedged into a cutting machine.

Although prior art brazing processes do reduce the material cost of manufacturing superabrasive inserts, the process, and in particular the brazing operation itself; is labor intensive and often costly. The brazing process is labor intensive because the operator has to pay close attention to the joint interface, for example the abrasive cutting edge, the braze interface layer, and the insert body need to be aligned accurately, so as to assure sufficient bonding when the materials are molten. The ultimate location of the abrasive cutting edge within the insert body and the quality of its attachment can be variable due to variable braze metal flow and therefore the need for such manual positioning of the parts.

Another difficulty in the brazing process is that cutting tool materials of different composition or grain size frequently require different brazing conditions, such as, temperatures, times, and braze metal formulations. Additionally, brazing dissimilar materials, for example, a cubic boron nitride cutting edge to a cemented carbide insert body, requires special braze alloys and conditions capable of bonding both materials simultaneously in the same process cycle. PCBN and PCD are known to be difficult to wet with brazes unless active metals, such as Ti or Fe, are incorporated into the metal formula. Such active metals are oxidation sensitive and may require use of an inert atmosphere or vacuum furnace, or very fast induction brazing to improve the bond. They also require the use of higher temperatures that may in turn lead to degradation of the superabrasive material.

A further disadvantage of conventionally brazed inserts is that once formed, then cannot be heated above the sublimation or liquids temperature of the braze metal in subsequent processing steps, such as, for example, chemical vapor deposition (CVD) coating of the insert. Low melting metals used in braze alloys, for example, Sn and Zn, are volatile and the braze bond may be impaired and/or vacuum components may be contaminated by thermal treatment after brazing. Moreover, damage to the abrasive cutting edge or insert body from the thermal expansion/contraction cycle during brazing is possible, thereby requiring brazing temperature and time to be kept to a minimum. In some cases, rebrazing cutting edges to correct braze flaws or regrind cutting edges is not possible. Furthermore, heat generated at the cutting edge during cutting may damage the braze attachment, allowing the cutting edge to displace in the holder, thereby disrupting the cutting operation. Further, U.S. Pat. No. 2,944,323 (“the '323 patent”) titled “Compound Tool”, which is incorporated by reference herein in its entirety, teaches ways to integrally form a cutting tool comprising of a hard metal cutting element and tool body. Specifically, the '323 patent teaches methods of anchoring a hard-metal cutting element to a tool body by various processes such as casting, molding and die-pressing. However, the cutting element described in the '323 patent is limited to hard metals such as stellites. Hard metal cutting tools are used at cutting speeds less than 150 fpm (45 ml/s). Operating at higher cutting speeds results in a rapid increase in temperature in the cutting zone. Such hard metal cutting tools have limited hot-hardness (hardness at elevated temperature) and can only be used for cutting temperatures Lip to 550° C. (see for example “Fundamentals of Machining and Machine Tools”, Geoffrey Boothroyd and Winston A. Knight, Marcel Dekker (1989)).

Heat generated during the cutting process has to be dissipated away from the cutting edge. The “patent teaches one method, that is, to conduct heat away from the cutting edge through the tool and the adjoining tool body. However, one limitation of this method when applied to superabrasive or ceramic cutting tools consisting of an abrasive tip attached to insert body by means of brazing, welding or other temperature assisted joining processes is that it increases the likelihood of abrasive tip-insert body joint softening leading to eventual separation. There are a number of references for specialized cutting tools that preclude the brazing requirements, including U.S. Pat. No. 5,829,924 titled “(Cutting Tool with Insert Clamping Mechanism,” U.S. Pat. No. 4,909,677 titled “Throw Away Cutting tool,” U.S. Pat. No. 5,154,550 titled “Throw Away flipped Drill Bit,” and U.S. Pat. No. 4,558,974 titled “Tool System for Precision Slotting.” The teachings of these patents rely on exact and complex geometrical configurations of an insert and cutting tool holder to assure that the cutting toot holder in operation securely grips the insert. These references, however, employ mechanical means of holding all insert in a cutting tool holder and not holding an abrasive cutting edge within the insert body itself.

Accordingly, there is a need for cutting tool inserts which overcome the disadvantages of conventional tool inserts, brazed tool inserts, such as and a method of making thereof.

### SUMMARY

An embodiment of the invention includes a cutting tool insert. The cutting tool insert includes at least one abrasive tip, where the abrasive tip includes at least one cutting edge, and an insert body material molded thereon. The abrasive tip may include, for example, a superabrasive material, or other materials as described herein. For example, the abrasive tip may include diamond, cubic boron nitride, carbides, ceramics, oxides, nitrides, composites, laminates or mixtures thereof. The abrasive tip may be non-deformable. The abrasive tip may have a higher hardness than the molded material.

An embodiment of a cutting tool may include a cutting tool insert, where the cutting tool insert includes at least one abrasive tip that includes at least one abrasive cutting edge, and an insert body. The insert body may include a moldable material and the moldable material may be adhered to a portion of the abrasive tip. A cutting tool holder may also be included, where the cutting tool holder receives the cutting tool insert.

An additional embodiment of a cutting tool insert may include at least one abrasive tip with an abrasive cutting edge, and a molded metallic insert body. Molding may include casting, powder metal injection molding and sintering, powder metal pressing and sintering, or plastic forming, all of which are familiar to those of ordinary skill in the art. The metal may include ferrous alloys, non ferrous alloys, metal bonded composites, such a composite carbides, and metal matrix composites.

A further embodiment of the invention may include at least one abrasive tip and a molded ceramic insert body. Molding may comprise casting, powder ceramic injection molding and sintering, powder ceramic pressing and sintering, or plastic forming and sintering, all of which are familiar to one of ordinary skill in the art. The ceramic material may include oxide and non oxide ceramics, glasses, and reinforced ceramic matrix composites.

In some embodiments, the moldable material may include a carbide material.

In some embodiments the insert body may further include structural enhancing components, thermal components, physicochemical components, or mixtures thereof. In other embodiments, a cutting tool insert may further include a tribochemical body.

In some embodiments, the polymeric material may be an insert body, and the polymeric material may include a moldable resin, a metal resin blend, a thermoset resin, a thermoplastic resin, or blends thereof. In yet other embodiments, the polymeric material may include a composite or compound of inorganic and resinous materials.

In still other embodiments, the cutting tool may include the at least one abrasive tip that may be selected from diamond, cubic boron nitride, superabrasives, carbides, ceramics, oxides, nitrides, composites, laminates or a mixture thereof. In other embodiments, the at least one abrasive tip may have a Vickers scale hardness of greater than about 1000.

In certain embodiments, the at least one abrasive tip further includes protrusions, depressions, mixtures thereof or other geometric features that aid in securing the abrasive tip to insert body.

The at least one abrasive tip or the cutting tool insert of embodiments may include a coating, the coating may include metals, ceramics, oxides, organic resins, or any laminate, composite or mixture thereof.

The cutting tool insert of some embodiments may include an abrasive tip with an abrasive cutting edge, a molded insert body, and tribochemical (TC) body or insert (“TC insert” and “TC body” are used interchangeably herein). The tribochemical body may be placed in the insert body to modify the wear, friction, and/or chemical behavior of the cutting tool insert. The tribochemical component may be adjacent to at least one surface of the abrasive tip.

A method embodiment may include providing at least one abrasive tip comprising an abrasive edge, providing a moldable material to form an insert body, and insert-molding the at least one abrasive tip and material to form a cuttings tool insert.

In some embodiments the material may include a moldable resin, a metal resin blend, powdered metal, a metal, a thermoset, a thermoplastic resin, ceramic-resin, or blends thereof. In still other embodiments, the material may include a composite or compound of inorganic and resinous materials, a metal matrix composite, or a ceramic/glass matrix composite. In some embodiments the moldable material may be selected from the group consisting of polymeric material, ceramic material, carbide material, metal material or blends thereof.

In certain embodiments, the step of insert-molding the insert may include simultaneously forming the insert body and attaching, the insert body to the abrasive tip. In still other embodiments, a method includes insert molding where the insert molding includes at least one of injection molding, transfer molding cold pressing, heating, casting, or sintering, all of which are familiar to one of ordinary skill in the art. In still other embodiments, insert-molding may be conducted at a temperature of up to about 1500° C. Certain embodiments also include insert-molding at a pressure of up to about 250 ton/inch².

In some embodiments the cutting tool insert may be heated after insert-molding. In still other embodiments the cutting tool insert may be cooled after insert molding.

Some embodiments may include coating the at least one abrasive tip prior to insert-molding, and some embodiments may include grinding the cutting tool insert.

Some embodiments may include powder molding operations to form polymeric, metallic, ceramic or composite insert bodies. The molding operation may be followed by binder removal operations and sintering operations. Binder removal from the insert body may include for example, but not limited to, vacuum-firing, air-firing to oxidize the binder and other binder removal methods familiar to one of ordinary skill in the art.

In other embodiments, a cutting tool may include at least one abrasive tip that contains an abrasive cutting edge, and an insert body. The insert body may include a moldable material that may include polymeric materials, ceramic materials, carbide materials, metallic materials, composite materials or mixtures thereof. In embodiments, the moldable material may be adhered to a portion or the entire abrasive tip. The insert body may further contain structural enhancing components, thermal components, physicochemical components or mixtures thereof.

### BRIEF DESCRIPTION OF THE DRAWINGS

FIG. 1A depicts a cutting tool insert of the prior art.

FIGS. 1B-1C include a top and side view of a cutting tooling setup of the prior

FIGS. 2A-2C are a selection of top-view illustrations of various insert-molded cutting tool insert according to various embodiments of the present disclosure.

FIG. 3 is an embodiment of a cutting tool insert with a cutting blank containing a protrusion.

FIG. 4 is an embodiment of a cutting tool insert with a cutting blank containing a depression.

FIG. 5 is an embodiment of a cutting tool that includes a tribochemical body.

FIG. 6 is a diagram illustrating an exemplary cutting tool insert manufacturing process.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein and in the appended claims, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

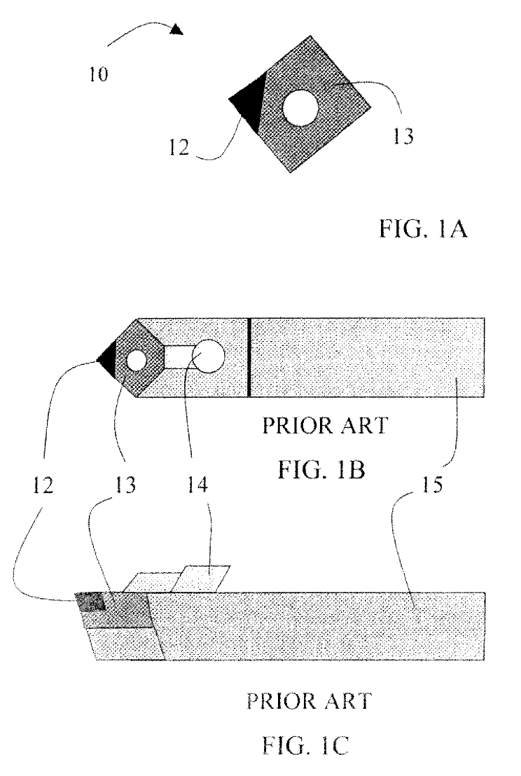

As used herein, the term “insert” refers pieces of superabrasive, ceramic and/or carbide (such as tungsten carbide) or alternative cutting material held within an insert body”, which are used in shaping or material removal equipment and are discarded or replaced when worn out. An example illustrated in FIGS. 1A-1C is a prior art cutting tool, where insert 10 includes insert body 13 and abrasive cutting edge 12 where the insert 10 is firmly held and mechanically locked into a cutting tool holder 15 by a screw or other clamping mechanism 14.

As used herein, the term “cutting tool holder” refers to the rigid body that holds an insert or inserts firmly in place so that they can be utilized in a turning, milling, boring, cutting, or drilling application (see for example FIGS. 1B and 1C where the cutting tool holder 15 receives the cutting tool insert 10).

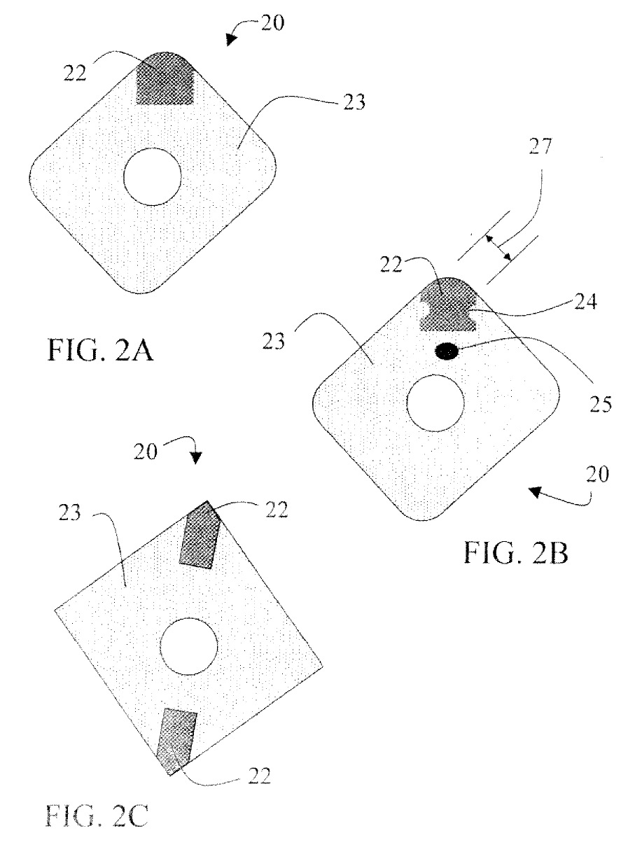

Referring to FIGS. 1A-1C, the invention generally relates to an insert 20 including an abrasive tip 22 with an abrasive cutting edge and an insert body 23. The invention hereby incorporates by reference in its entirety the disclosure of U.S. patent application Ser. No. 10/690,761 entitled “Cutting Tool Inserts and Methods to Manufacture”. FIGS. 2A and 2B illustrate the insert 20 including the insert body 23, a material insert-molded onto a portion of the abrasive tip 22. In particular, FIGS. 2A and 213 illustrate two styles of abrasive tips with cutting edges in black resin bodies, both of which have been edge-ground and are ready for use. The circular depression in FIG. 2B is the impression left from the mold eject pin 25. FIG. 2C illustrates a molded 20 insert with two abrasive tips 22, prior to grinding operation.

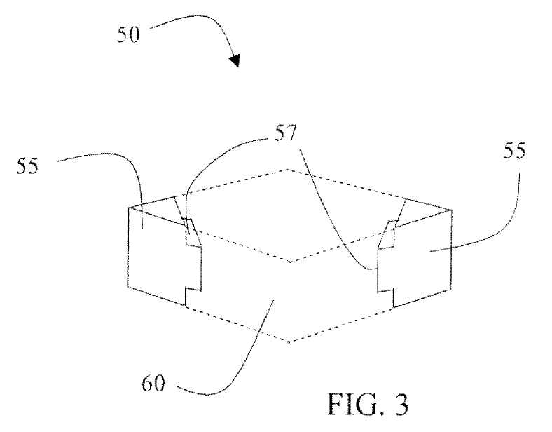

In an embodiment depicted in FIG. 3, a molded cutting tool insert 50 may include a cutting blank 55 that may further include a protrusion 57, A protrusion 57 may be a bulge or multi-sided projection that projects from a side of a cutting blank. The protrusion 57 may be embedded into the insert body 60, and may further increase the adhesion of the cutting blank 55 to the insert body 60.

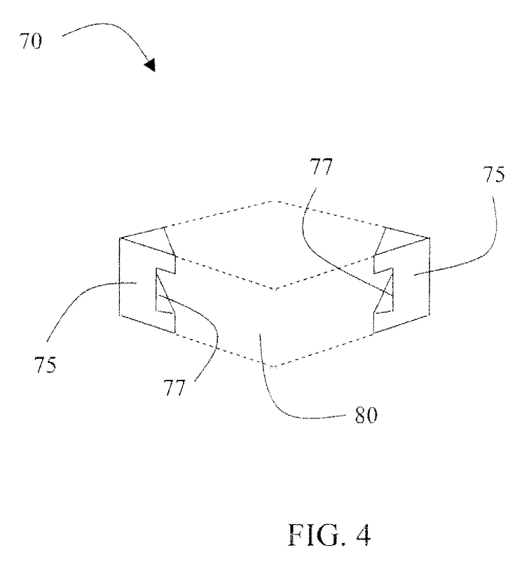

In an alternative embodiment depicted in FIG. 4, a molded cutting tool insert 70, may include a cutting blank 75 that may further include a depressed area 77. The material of the insert may penetrate the depressed area 77, and may further increase the adhesion of the cutting blank 75 to the insert body.

Referring again to FIGS. 2A-2C, an abrasive blank 22 with a cutting edge may include any material that can be used in sawing, machining, cutting, or drilling applications, including, but not limited to carbides, ceramics or superabrasives such as silicon nitride, silicon carbide, boron carbide, titanium carbide-alumina ceramics such as titanium carbide, fused aluminum oxide, ceramic aluminum oxide, heat treated aluminum oxide, alumina zirconia, iron oxides, tantalum carbide, cerium oxide, garnet, cemented carbides (e.g. WC—Co), synthetic and natural diamond, zirconium oxide, cubic boron nitride, laminates of these materials, mixtures, and composite materials thereof. These materials may be in the form of a single crystal or sintered polycrystalline bodies. The abrasive blank may be of any material that is less deformable (harder) or more abrasion resistant than the work piece material. Preferably, the abrasive blank may have a Vickers scale hardness of greater than about 1000. Sintering techniques known well in the art may be used for making the abrasive blank 22. The abrasive blank 22, and insert body 23, may have any geometry and orientation to each other.

In an embodiment, the abrasive tip 22 may have a thickness that is substantially similar to that of the insert body 23. This combination allows for use of top and bottom edges of the abrasive tip 22. The abrasive tips may be in the form of single crystals, sintered polycrystalline bodies, or laminate bodies with abrasive material on upper and lower layers of the abrasive tip 22.

Abrasive compacts or blanks including polycrystalline diamond (PCP) or polycrystalline cubic boron nitride (PCBN) may also be utilized for abrasive tip 22 and are commercially available from a number of sources, including, Diamond Innovations Inc. under the trade names COMPAX® and BZN®, respectively. PCD and PCBN compacts may include a suitable bonding matrix of about 5% to 90% by volume. The bonding matrix may be a metal such as cobalt, iron, nickel, platinum, titanium, chromium tantalum, copper, silicon, or an alloy or mixture thereof and/or carbides, borides, or nitrides or mixtures thereof. The matrix additionally may contain a recrystallization or growth catalyst such as aluminum for CBN or cobalt for diamond.

The compacts nay be PCBN discs having a thickness of about 0.1 mm to about 15 mm. In another embodiment, the PCBN compacts may have a thickness of about 1.6 to about 6.4 mm. The forming of the compacts may be done via processes known in the art including Electro Discharge Machining (EDM), Electro Discharge Grinding (EDG), grinding, laser, plasma, grinding and water jet. Geometries of cut pieces may be predetermined and computer controlled to maintain tight tolerances.

In an embodiment, a PCBN blank may be formed into a shape by means of an abrasive water jet. In another embodiment of the invention, a PCBN blank may be laser-etched at selected positions on the surface according to a predetermined computer controlled pattern, for example, forming a polygonal shape with two of the sides forming about an 80° triangle with about 5.0 mm cutting edge length, and the rest of the straight sides forming a zigzag shape for subsequent interlocking with the mating feature in the insert body.

In some embodiments, an abrasive tip 22 may have an abrasive cutting edge with a length 27 (FIG. 2B) of 0.5 mm to 25.4 mm, including angles of 20 to 90° in any plane of reference. In a second embodiment, the abrasive tip 22 may be of a thickness of about 0.5 mm to 7 mm. Abrasive tip 22 may be a circle, oval, octagon, hexagon, partial or complete ring shape, or the like, multiple edges, and may be of any size for use in cutting tools.

The insert 20 includes a material forming an insert body 23. The insert body 23 may be insert-molded and in contact with an abrasive tip 22 with an abrasive cutting edge or alternatively onto a portion of the abrasive tip 22 with an abrasive cutting edge. Insert molding is defined as the process of molding a plastic or other flowable material around a preformed metal, abrasive, superabrasive, or other solid insert(s) (http://www.npd-solutions.com/injectmoldglos.html). During insert-molding, the insert body 23 may be simultaneously shaped and hardened. The abrasive tip 22 may further include additional geometric features 24 that further secure the abrasive tip 22 to the insert body 23. The insert body may include holes or recesses for fixturing the insert for chip flow control, identification, labeling and the like. The shaping and hardening of the insert body 23 may occur permanently by chemical reactions or by cooling and attachment to the abrasive tip 22. During hardening or curing, chemical reactions may occur within the insert body 23 material and between the insert body material and the abrasive tip 22. Optionally, no adhesive or braze metal or other intermediate layer is required to adhere the insert body 23 to the abrasive tip 22.

The material of the insert body 23 may, in some embodiments, be any (1) moldable polymeric material, such as thermoplastic or thermoset materials or (2) moldable metal compound, containing ferrous or non-ferrous alloys or pure metals; or (3) moldable ceramic compound, including oxide or non-oxide ceramics; or (4) moldable composite materials, including organic, metallic, or ceramic matrix composites.

In an embodiment, the material of the insert body 23 may be a thermoset or thermoplastic resin, for example, polyetherimide, polyamide, or phenolic type resin. A polymeric material of the insert body 23 may further be a moldable resin, a metal resin blend or blends thereof. A polymeric material may also include a composite or compound of inorganic and resinous materials, for example filled resins. The molded material of the insert body 23 holds the abrasive tip 22 with the cutting edge rigidly to the insert body 23 when the insert 20 is subjected to forces and heat involved in the cutting operation. The strength and stiffness of the molded material of the insert body 23 helps to avoid cracking of the insert. Accordingly, the material forming the insert body 23 has sufficient heat, ductility and strength to hold the abrasive tip with adequate strength during for example, cutting operations.

Optionally, the abrasive tip with the cutting edge adheres to the insert body material without any intermediate layer such as an adhesive or a metal braze. While not wishing to be bound by theory, the insert body material may be adhered to the abrasive tip through any combination of primary chemical bonding; secondary interactions, such as for example, but not limited to, dispersion forces, van der Waals interactions, hydrogen bonding and the like; and mechanical interlocking of the insert body material with topographical features of the surface of the abrasive tip. The abrasive tip may be adhered to the body by shrinkage of the insert body around the abrasive tip during a step, such as for example cooling, in an insert-molding, process.

Another embodiment includes a coating on one or more surfaces of an abrasive tip with a cutting edge or a coating on one or more surfaces of an insert. For example, prior to insert molding, a coating may be applied to one or more surfaces the abrasive tip. Alternatively, an insert may be coated on one or more surfaces after insert-molding. The coating may include metals, ceramics, oxides, carbons, resins, or any laminate composite or mixture thereof. The coating may serve to enhance abrasion resistance, insert identification, oxidation resistance or reduce chemical attack.

In some embodiments, ceramic powders such as natural minerals, for example, mica, or carbon fibers or tale, may be added to the flowable material to adjust hardness, heat resistance, grindability and strength. In other embodiments, the material may include pigments, for example, to identify different inserts. For example, diamond shaped inserts may be red and circular inserts may be blue.

In another embodiment, a method is generally directed to forming a cutting tool insert by insert molding. Initially, abrasive tip and a moldable material may be provided. The material, which forms insert body, may be insert-molded onto a portion of the abrasive tip with a cutting blank to form the insert. Insert-molding generally refers to any molding process whereby a flowable material, such as powder or solid/fluid mixtures comprising plastics, metals or ceramic powders or mixtures thereof, is introduced into a mold and around a portion of an insert piece, in this case the abrasive tip, placed into the same mold prior to molding. Cooling and thermochemical shrinking and hardening occurs in the mold with the abrasive tip. This accomplishes both attachment of the abrasive tip(s) and manufacture of the insert body to form insert. Optionally, attachment occurs without the need for an intermediate layer such as an adhesive or a metal braze. Furthermore, providing the moldable resin material conforms to, contacts, wets and adheres to the abrasive tip(s), attachment via adhesion is created. Any number of geometrical features 24 (see FIG. 2) may be added to the abrasive tip to improve attachment. The insert may be produced by any molding process such as, but not limited to, injection molding, compression molding forging and casting.

A flowable material for insert molding is one that changes shape with stress and does not deform the abrasive tip. Additionally the flowable material may conform to the abrasive tip at pressure or stress less than about 250 ton/in² and at temperatures less than about 1500° C. The flowable material fills the mold to form the shape of the cutting tool insert body. It also conforms, wets or contacts the abrasive tip(s) that make up the cuttings tool insert, and are held within the mold. Flow under pressure typically improves the contacting or ‘packing’ of the mold and speeds up mold filling.

Heat or cooling may be applied to the mold under pressure, to cause the flowable material to thermochemically, thermally and/or by surface tension, contract in all dimensions uniformly and simultaneously, and thus squeeze, and/or adhere to, the abrasive tip(s). The flowable material may be designed to chemically adhere to the abrasive tip material to add bonding strength. The flowable material may be selected to chemically react with a specific material of an abrasive tip. For example, a polymeric material of a melamine phenolic resin may be chosen so that the polymer precursors chemically react with a cutting blank that contains diamonds as the abrasive tip material during curing in the insert molding process. Thermochemical and/or surface tension (i.e. sintering) reactions may increase hardness of the flowable material and improve thermal stability.

Any conventional mold, such as a steel mold, may be utilized for forming the insert. The mold may be of any desired shape of the cutting insert, for example, a diamond-shaped cavity may be utilized. Additionally, the mold may vary in shape, size or thickness and may correspond to the desired cutting tool holder shape or size. The mold may be able to accept a single abrasive tip or may be able to receive a plurality of abrasive tips. In an embodiment, the abrasive tip may initially be placed in the mold and then the material introduced into the mold. The mold may then be either heated, cold pressed, or both to form a hard composite of the insert including the abrasive tip with a cutting blank and the insert body to form the insert.

In another embodiment, the mold may include pins into which an operator or robot may drop or place the abrasive tip or cutting blanks depending on the mold arrangement. The mold may also include pins-on-springs to clamp and hold the abrasive tips prior to the injection of the molten material under pressure. The mold may also have runners and gates to control the molten material flow and mold cavity fill.

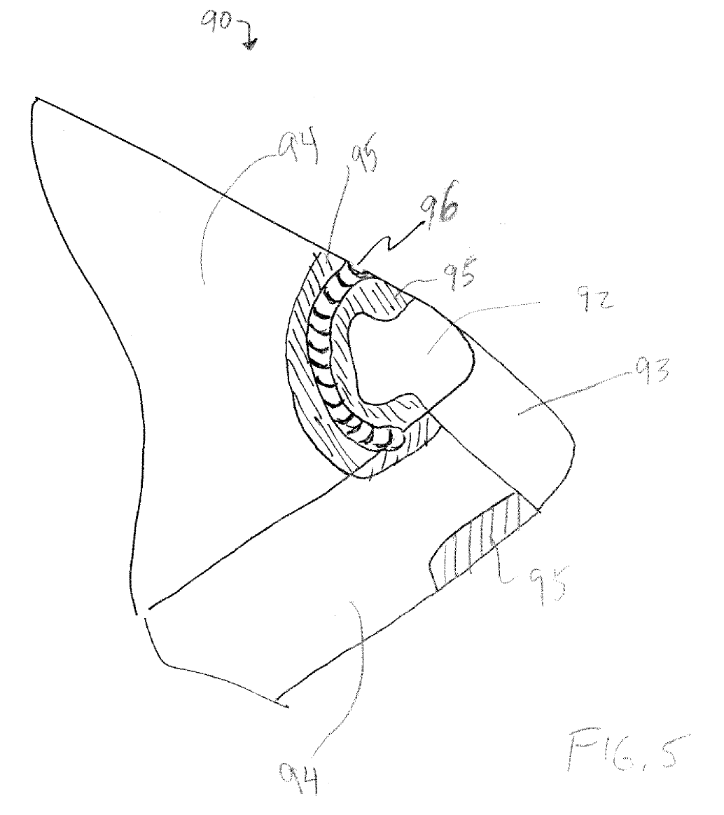

Referring to FIG. 5, a portion of a cutting tool insert 90 with a tribochemical body 91 is depicted. The cutting tool insert may contain an abrasive tip 92 with an abrasive cutting edge 93, a molded insert body 94, and tribochemical body 95. The tribochemical body 95 may be placed in the insert body 94 to modify the wear, friction, and/or chemical behavior of the cutting tool insert 90 and to extend the useful life of the cutting tool insert 90. The tribochemical component may be adjacent to at least one surface of the abrasive tip 92.

An active tribochemical (TC) insert can be molded into the cutting insert in the same manner as the abrasive tip. The insert has chemical, wear, thermal, frictional, or geometrical features that modify the cutting performance of the insert. The insert may protect the molded insert body from wear, extending the life of the insert. This increased life may be obtained by abutting the abrasive tip with a TC insert with higher wear resistance than the molded body, Materials may be any material more wear resistant than the molded insert body. For superabrasives, the TC insert may be any conventional WC material, hardened steel, ceramic, or similar materials. The TC insert may similarly protect the insert body from corrosion if comprised of materials more inert than the insert body.

For a polymeric insert body, a corrosion resistant TC insert might be metallic, a more inert polymer, and a ceramic or like material. The TC insert may also be a component that physically directs the cutting debris and chips away from the molded insert body, such as or example, but not limited to, a groove. Materials with an appropriate wear chemical resistance and a grooved chip breaker geometry as known in the art could be included. Similarly, the TC insert may provide lubrication benefits by incorporating the various solid or liquid lubricant employed in cutting, applications, which are known or hereafter to one of ordinary skill in the art.

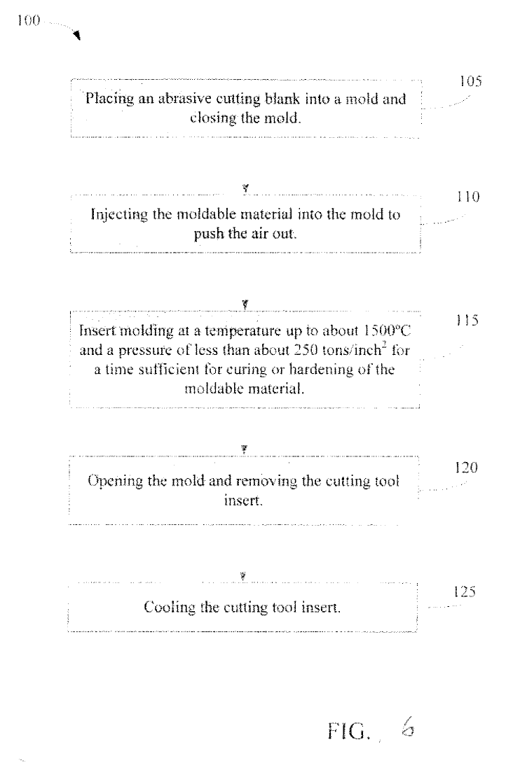

Referring to FIG. 6, an embodiment of a method to manufacture molded cutting tool inserts 100 may include an operator or robot placing an abrasive tip into the heated cavity within the pins, floor, and walls of the mold and then close the mold 105. The warm moldable material under pressure may be injected into the mold 110 to push the air out or vacuum may be used. Optionally, a binder removal step, such as vacuum-firing or air firing or others equally known to those of ordinary skill in the art may be employed to remove any binder material. The material may be molded 115 at a temperature of up to about 1,500° C. and at a pressure of less than about 250 ton/in². For moldable plastics, pressures less than about 5 ton/in² and temperatures of less than about 300° C. are preferred. For moldable metal, pressures less than about 25 ton/in² and temperatures less than about 1500° C. are preferred. The warm, viscous material flows over and around the abrasive tip(s). The abrasive tip may generally be held against the fluid forces during mold fill using the pins, springs, and cavity walls of the mold. The warm material then may be packed or pressed to squeeze out any voids, improve conformal contact, and to minimize subsequent volume change on cure. The warm material may be heated further by the mold's hot walls, radiation or other method, and may undergo a heat- and/or pressure-activated chemical reaction causing it to harden by polymerization and therein shrink. The warm material may also be allowed to cool in the mold and thus harden without chemical reaction. After sufficient time to allow for cooling and/or hardening, the mold may be opened and parts pushed out by pins set into the mold body 120. The new part or insert may then be allowed to cool 125 using any standard cooling process, including exposure to ambient temperature. A new abrasive tip may then be placed into the mold and the process repeated.

In alternate embodiments, further curing, hardening annealing, tempering of the insert-molded body may be accomplished outside the mold by exposure to UV radiation or heating optionally under a pressure of 1 atmosphere pressure or higher.

In alternate embodiments, the molded insert may be made using metal-resin, ceramic-resin, or metal-resin-ceramic molding such as metal injection molding. Metal injection molding includes mixing fine metal and/or ceramic powders with plastic binders to render the metal powder more flowable, The abrasive tip(s) is placed in the mold as usual, and metal, resins and binder compounds may be pushed under heat and pressure into the mold around the abrasive tip. After hardening, cooling and/or shrink of the resin, the molded insert may then be stripped of plastic by solvent extraction or vaporization leaving a porous metal-abrasive tip insert. The insert body may then be furnace sintered to form a dense, hard insert.

In alternate embodiments, the molded insert may be made using flowable metal powder blends, where mold fill may be accomplished by gravity. Parts may be pressed cold to form non-dense, non-hard green bodies and then sintered in a furnace to shrink and harden, as well as establish contraction stress and adhesion with the abrasive tip(s). Alternatively, curing may be performed in the same mold as the fill by hot pressing.

In alternate embodiments, the molded insert may be made in a hot press by positioning the abrasive tip into the cool mold, adding metal powder, closing the mold and increasing heat and pressure to cause the metal powder to sinter around the abrasive tip.

The molded cutting tool insert may be finish ground, polished, or otherwise further machined to remove irregularities, asperities etc, in its shape to aid in fit within the cutting tool holder. The shaping of the insert may be carried out using any of the processes including but not limited to Wire Electro Discharge Machining (WEDM), milling, laser cutting, or grinding. For example, the insert may be ground to a variety of shapes including hones, chamfers, wipers (multiple cutting nose radii), rake angles, clearance angles, and the like known to the art without limit. In another embodiment of the invention, the cutting tool insert body may include chip-breaking patterns, alignment holes, or chamfers within or on its body. Additionally, an electroless nickel chromium hard coat, or subsequent PVD or CVD ceramic hard coating may be applied to the insert body to protect the insert.

The molded insert body may include additional components, such as structural enhancement components, to increase strength, toughness, or resistance to deformation. The molded matrix which, as described above, may be polymeric, metallic, or ceramic, may include reinforcing components. The term “structural enhancement components” as used herein, includes, but are not limited to, reinforcing components such particles, whiskers, or filaments. These particles, whiskers or filaments may be any of those commonly and used to reinforce composites, and are familiar to one of ordinary skill in the art. These reinforcements may be glass, ceramic, metallic, alloys, nanoparticles, or polymeric. The reinforcements may be coated or other wise treated to increase or decrease their adhesion to the matrix as is known in the art. The reinforcements may be continuous or discontinuous. The reinforcements may be included in the insert body at concentrations from about 14% to about 50% (vol.). Other concentrations are possible and are known to one of ordinary skill in the art.

The molded insert body may additionally include thermal components to modify the thermal properties of the insert. The term “thermal component” as used herein includes materials that are known by one of ordinary skill in the art that can be used to modify the thermal properties of another material. The thermal components may increase or decrease the thermal conductivity of the matrix body. The thermal components may include particles, whiskers, or filaments. The thermal component may be continuous or discretely distributed within the body. The thermal component may reduce the thermal conductivity of the molded body to increase the temperature of the cutting edge, the abrasive tip, or the chip produced in the cutting operation. The component may be added to decrease the thermal energy distributed to the insert tool holder and other mechanical components. The thermal components may be included in the insert body at concentrations from about 1% to about 50% (vol.). Other concentrations are possible and are known to one of ordinary skill in the art.

A method that is adopted in this invention is to increase the thermal resistance of the cutting insert. This effectively changes the partition of heat energy, resulting in higher fraction of the heat energy going to the work material or the chips. This ensures that the attachment of the abrasive tip to the insert body is maintained even at higher cutting speeds.

The molded insert body may further comprise additives that modify the chemical or physical aspects of the cutting operation and are described herein by the term “physicochemical components”. The physicochemical components of an insert body may include liquid or solid lubricants as are known in the art to reduce friction forces in the tip or insert body. The body may include physicochemical components such as, for example but not limited to, chemical modifiers that reduce cutting forces, and are known as cutting or grinding accelerants to one of ordinary skill in the art. These chemical modifiers may contain sulfur, phosphorus, chlorine, fluorine, or other cutting accelerants known in the art.

Inserts of any variety of shape, size, or thickness, attachable to a wide variety of cutting tool holders for use in turning, milling, boring, sawing, and drilling applications may be created. The bonded insert of the present invention may contain multiple abrasive tips (limited only by insert shape) and may not require external clamps, body wedges, or fixture constraints.

The Examples below are merely representative of the work that contributes to the teaching of the present invention, and the invention is not to be restricted by the examples that follow.

### EXAMPLE 1

Diamond-shaped CNUA43 cutting inserts were molded by the method described above using a thermosetting melamine phenolic resin (Plenco grade 0641 glass-fiber and mineral filled). A hard steel mold containing spring-loaded pins was used. The abrasive tip(s) were HTM 2100 material (Diamond innovations Inc.). HTM 2100 comprises 0.5-1 mm of hard PCBN composite bonded to about 1.5 to 2 mm of sintered tungsten carbide. The 80 degree trapezoidal cutting blanks were EDM Cut with radius at the cutting blank to 0.008″ to provide a seal for the flowable resin. The cutting blanks were prepared to provide adequate contact with the curable resin to improve adhesive attachment. The cutting blanks were placed into the cavity comprising the mold and located via small pins. Preheated resin was then pressurized into the mold and flowed over and around the cutting blanks. A seal was made and pressure increased. The mold was heated and time was allowed for complete mold fill, removal of air, resin shrink and cure/hardening of the hot thermosetting resin. The molded pieces were subsequently cooled and fabricated via grinding into CNGA432 inserts with 25 deg×0.005″ chamfer and medium hone. The edges ground surprisingly well demonstrating minimal wheel wear, low forces, and a fast grinding process due to the soft plastic and the non-sticky plastic debris, which reduces the need to clean or dress the grinding wheel. The attachment of the abrasive cutting tip by the plastic was surprisingly good.

Thirty pieces of the above molded inserts were subjected to a machine grinding evaluation (Agathon Combi machine with EcoDress system) of parts per wheel, parts per minute, and grinding forces versus standard carbide and steel inserts. All 30 pieces were ground with no loss of cutting blanks, no movement of cutting blanks, chipping or dimensional problems. The above molded inserts were evaluated in outside diameter turning of grade 1018 cold-rolled steel at 150 sfpm, 0.004 ipr, and 0.010″ doc. In 20 passes only minor erosion of the plastic was noted. The cutting blanks did not move, fall out or chip. The plastic did not melt, soften, weaken, crack, or otherwise release the abrasive cutting tip(s).

The cutting tests below demonstrate the ability of the molded insert compared to conventional inserts.

The above molded inserts were evaluated in facing of high-Cr steel type 52100 thru-hardened steel disks. The molded insert made 22 passes with normal wear, while a brazed insert, with a standard carbide material, using the same HTM 2100 cutting blank material, made only 16 passes to the same level of wear. These cutting tests demonstrate the utility of the molded inserts compared to conventional inserts.

### EXAMPLE 2

Table 1 illustrates a table of cutting tool performance as measured by inches of steel cut divided by 0.001″ inches of flank wear to the insert cutting blank. Inserts of the present invention prepared from PCBN composite abrasive edges and filled melamine phenolic resin were tested against brazed inserts in continuous facing of hard 52100 and notched hard 4340 steels. In all cases, no cutting blank attachment issues were identified. The cutting blank material, not the molded body material, determined insert performance.

TABLE 1

| Performance | Performance | | |
|---|---|---|---|
| (in/0.001″ flank wear) | (in/0.001″ flank wear) | | Cutting Conditions |
| Insert-Molded Cutting | Standard Cutting | | speed (feet/min); feed |
| Tool Insert | Tool Insert | Steel Type | (in/rev); depth-of-cut (in); dry |
| 5836 | 6897 | 4340 | 361; 0.005; 0.01 |
| 6077 | 7153 | HRC 48–52 | |
| | | V-notched | |
| | | (interruption) | |
| 6072 | 8552 | HRC 48–52 | 361; 0.005; 0.01 |
| | | V-notched | |
| | | (interruption) | |
| 9637 | 11795 | 52100 | 324; 0.003; 0.01 |
| | | HRC58–60 | |
| | | Facing | |
| 10309 | 8267 | 52100 | 324; 0.003; 0.01 |
| | | HRC58–60 | |
| | | Facing | |
| 9563 | 9962 | | |

### EXAMPLE 3

The above ground plastic molded insert was metallized with about 2 microns of electroless nickel via a standard Solution process by Diamond Innovations, Inc. The electroless nickel coating was confirmed conductive. In a machining test, the metal hard coat as a “hard shell” on the plastic preventing hot chips from eroding the plastic,

### EXAMPLE 4

An HTM 2100 abrasive cutting edge of the same style as in Example 1 was mixed with line 8-micron carbonyl iron powder and hot pressed at 850° C. for 3 minutes in a graphite mold. The insert was ground to reveal an abrasive cutting edge, free of cracks and chips, and with excellent attachment of the abrasive to the sintered metal. This indicates that insert-molding can be accomplished with flowable metal powders.

Embodiments of the disclosure may provide numerous advantages. For example, the molded cutting tool inserts as described herein perform, during metal cutting, are cooler than standard cutting, tool inserts with steel or carbide because of the insulative nature of the plastic material insert body described herein. Moreover, the cutting edge attachment is assured and there is no impact by, chips on the insert body.

Additionally, the molded insert body described herein facilitates grinding compared to harder carbide or soft steel. This allows for improvements such as, for example an increase in production speed, a decrease in grinding wheel wear, and a decrease in fabricator costs, including improving grind machine capacity in terms of parts per hour and expensive wheel costs in parts per wheel. The manufacturing process also is reduced due to minimal labor to process the insert assembly without requiring, precision cutting or fitting.

The insert-molding operation may also be fully automated, thereby reducing costs and increasing efficiency. Additionally, there are no significant gaps or misfits because the chemical shrink with the adhesion resin-to-cutting edge assures bonding. Also, the molded plastic insert does not get hot during cutting. Since plastic is a thermal insulator, unlike steel and carbides, more heat remains in the insert and, therefore, the cutting tool using the insert will be cooler or a lower temperature.

An additional advantage of molding inserts as described herein is that, in some embodiments, the dimensional precision to form a bond between the insert body and the abrasive cutting edge normally required for brazing and/or press fit attachment of a pre-manufactured, solid (non-flowable) is no longer required. Thus, the abrasive cutting edge may be cut by faster, less precise means since the material is flowable and will thus change shape to conform to and contact with the abrasive cutting edge(s).

Another advantage of molding cutting tool inserts this way is that, in some embodiments, the abrasive cutting edge(s) may be shaped with complex shape features, such as fins teeth, sharp corners, without concern of impairing braze flow or breaking the cutting edge in a mechanical attachment (e.g., press fit) method. Such complex shape features may be used to improve the attachment of the abrasive cutting edge to the insert body.

Another advantage is that flowable moldable (especially highly-filled) plastic is substantially easier to grind than soft steel or hard carbide, which are conventional materials for cutting tools. This implies that fine features for example, chip breakers, cooling channels, man be put into the insert during insert grinding without prematurely dulling the grinding wheel. Such features may also be molded into the insert body. These molded-in geometric features may include, but not limited to, holes, keyways, alignment pins, chamfers, tapers, gear-teeth, depressions, numbers or logos.

It will be appreciated that various of the above-disclosed and other features and functions, or alternatives thereof may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A cutting tool comprising:
at least one abrasive tip comprising an abrasive cutting edge; and
an insert body, wherein the insert body comprises a moldable material, wherein the moldable material is adhered to a portion of the abrasive tip.

2. The cutting tool insert according to claim 1, wherein the moldable material comprises a polymeric material.

3. The cutting tool insert according to claim 1, wherein the moldable material comprises a ceramic material.

4. The cutting tool insert according to claim 1, wherein the moldable material comprises a carbide material.

5. The cutting tool insert according to claim 1, wherein the moldable material comprises a metallic material.

6. The cutting tool insert according to claim 1, wherein the insert body further comprises structural enhancing components, thermal components, physicochemical components, or mixtures thereof.

7. The cutting tool insert according to claim 1, further comprising a tribochemical body positioned to extend the useful life of the cutting tool insert.

8. The cutting tool insert according to claim 1, wherein the at least one abrasive tip comprises a superabrasive material.

9. The cutting tool according to claim 1, wherein the at least one abrasive tip comprises a ceramic material.

10. The cutting tool according to claim 1, wherein the at least one abrasive tip comprises a carbide material.

11. The cutting tool according to claim 1, wherein the at least one abrasive tip further comprises a protrusion, a depression, or a mixture thereof.

12. The cutting tool according to claim 1, wherein the at least one abrasive tip or the cutting tool insert further comprises a coating, the coating comprising a metal, ceramic, oxide, organic resin, laminate, composite, or mixtures thereof.

13. A method, comprising:
providing at least one abrasive tip comprising an abrasive cutting edge;
providing a moldable material to form an insert body; and,
insert-molding the at least one abrasive tip and moldable material to form a cutting tool insert.

14. The method according to claim 13, wherein the moldable material is selected from the group consisting of polymeric material, ceramic material, carbide material, metal material or blends thereof.

15. The method according to claim 13, wherein the moldable material further comprises a structural enhancing component, a thermal component, a physicochemical component, or a mixture thereof.

16. The method according to claim 13, wherein the step of insert-molding the insert comprises simultaneously forming the insert body and securing the insert body to the abrasive tip.

17. The method according to claim 13, wherein the step of insert-molding the material further comprises at least one of injection molding, transfer molding, casting, cold pressing, heating, sintering, or binder removal.

18. The method according to claim 13, further comprising the step of heating the cutting tool insert after insert-molding.

19. The method according to claim 13, further comprising the step of coating the cutting tool insert.

20. The method according to claim 13, further comprising the step of coating the at least one abrasive tip prior to insert-molding.

21. The method according to claim 13, further comprising the step of grinding the cutting tool insert.

22. A cutting tool insert comprising:
at least one abrasive tip comprising an abrasive cutting edge; and
an insert body, comprising:
a moldable material comprising polymeric materials, ceramic materials, carbide materials, metallic materials, composite materials, or mixtures thereof,
wherein the moldable material is adhered to a portion of the abrasive tip; and
an additive comprising a structural enhancing component, a thermal component, a physicochemical component, or a mixture thereof.
